(19) United States
(12) Patent Application Publication
(10) Pub. No.: US 2010/0080996 A1
(43) Pub. Date: Apr. 1, 2010

(54) BODY MEMBER WITH PHOTOCHROMIC DECORATION

(76) Inventor: Ichiro Ono, Tokyo (JP)

Correspondence Address: STAAS & HALSEY LLP, SUITE 700, 1201 NEW YORK AVENUE, N.W., WASHINGTON, DC, 20005, US

(21) Appl. No.: 12/450,740

(22) PCT Filed: Apr. 10, 2008
(86) PCT No.: PCT/JP2008/000944

§ 371 Date: Oct. 9, 2009

(30) Foreign Application Priority Data
Apr. 12, 2007 (JP) 2007-105085
Jul. 5, 2007 (JP) 2007-177092

(51) Int. Cl. B32B 27/38; B32B 9/04; B32B 27/30; B32B 27/40

(52) U.S. Cl. 428/413; 428/411.1; 428/500; 428/423.1

(57) ABSTRACT

A body member to be exterior parts of a portable device used both outdoors and indoors has a coating film containing a photochromic dye provided on at least a part of an internal surface of a transparent base material. Further, a plastic is used as the transparent base material. Besides, an ultraviolet absorbent that absorbs an ultraviolet ray having a wavelength shorter than a wavelength region in which a color developed by the photochromic dye is expressed is diffused in the transparent base material made of the plastic. In addition, the coating film containing the photochromic dye is formed by a coating liquid that contains a class of hindered amine light stabilizer or a class of hindered phenol light stabilizer.

### CROSS-REFERENCE TO RELATED APPLICATIONS

This application is a U.S. National Stage application claiming the benefit of prior filed International Application Number PCT/JP2008/000944, filed Apr. 10, 2008, in which the International Application claims priority benefit from Japanese Application Numbers 2007-105085 filed on Apr. 12, 2007 and 2007-177092 filed on Jul. 5, 2007, the entire contents of which are incorporated herein by reference.

### TECHNICAL FIELD

The present invention relates to a photochromic-decorated body member used as a body member of a mobile communication terminal typified by a mobile phone, a digital camera and the like.

### BACKGROUND ART

A body member of a mobile phone, a digital camera and the like is required to be light in weight, so that generally, an aluminum material or a plastic material is often used for the body member. A body member made of the plastic material is often formed by an injection molding of plastic material which is stained by a pigment or a dye mixed therein, and in recent years, a top finish process using a paint technology and the like has been often applied to the body member.

The paint technology is a technology for forming a film of coating on a surface of not only a metal material but also various materials, and can obtain a bright finish that enhances various colors provided by coatings, regardless of a color of base material and a feel of the material.

Generally, as a prerequisite, a coating used for the painting has to maintain the same color tone despite an elapse of time, a change in a surrounding environment and the like.

In addition to such a pigment or a dye that expresses a fixed color tone, there is also known a pigment or a dye whose color tone is changed depending on an environment such as a surrounding temperature.

A photochromic dye that expresses an inherent color when exposed to an ultraviolet ray and expresses no color when the ultraviolet ray is blocked is one of dyes having such a characteristic, and has been conventionally used for a photochromic lens and the like. Further, as a manufacturing method of such a photochromic lens, a method in which the photochromic dye is mixed in a plastic material itself to be a base material of a spectacle lens and the mixture is then solidified and a shape thereof is adjusted, a method in which the photochromic dye is adhered to a surface of a shapen spectacle lens using vacuum evaporation, and thereafter, the photochromic dye is diffused inside a base material (plastic or the like) of the spectacle lens, and the like have been proposed.

A mechanism in which the photochromic dye expresses the inherent color in accordance with the exposure to the ultraviolet ray is based on a property of a photochromic dye molecule whose structure is changed to a molecular structure having an absorption band in a visible spectrum when the molecule absorbs an energy of ultraviolet ray, and it is known that the photochromic dye molecules are lost little by little in accordance with the change in the molecular structure (refer to Non-Patent Document 1).

Non-Patent Document 1: written by Kunihiro Ichimura, “Photo-Functional Chemistry”, published by Sangyo Tosho Co., Ltd., “Section four: Evaluation of photochromism”

### DISCLOSURE

### Problems to be Solved

Incidentally, scenes where a portable device such as a digital camera, a mobile phone, and a portable music player is used are roughly classified into indoors and outdoors, in which it is conceivable that a typical scene of use in indoors is a relaxation space such as a living room of one's home, and a scene of use in outdoors is, on the other hand, an athletic festival, a travel, a leisure and the like, which are conducted during an active time. Meanwhile, it is also conceivable that a main scene of use in indoors is a formal occasion related to business, and a main scene of use in outdoors is a private occasion. Further, when a variety of tastes of a user are considered, it is quite possible that the user wants different appearances depending on the scenes. If anything, it is natural to think that a favorable feel of materials that the user of these portable devices prefers with respect to the appearances of the portable devices differs depending on the respective scenes having different characteristics as described above.

As a product that changes appearances indoors and outdoors, the aforementioned photochromic lens is known. However, in a conventional photochromic lens, an emphasis is mainly put only on a light control performance (namely, a high absorptance of ultraviolet ray and visible ray, and a high reaction rate) provided by the photochromic dye because of its original purpose, and a color exhibited by the photochromic dye in accordance with the absorption of the ultraviolet ray has never been considered.

Further, originally, the photochromic dye is more expensive than a dye or paint used for a general coloring technique, and besides, it is known to have a light fastness lower than that of the general coating since the photochromic dye molecules are lost, even little by little, when the photochromic dye is exposed to the ultraviolet ray to develop colors, as described above. For this reason, although the photochromic dye has an inherent function for changing the appearances outdoors and indoors, it has not been used for applying top finish to a part such as a body member that is exposed to a natural environment.

The present invention has a proposition to provide a photochromic-decorated body member having a light fastness with such a level that it can be used as a body member that is exposed to a natural environment.

### Means for Solving the Problems

The aforementioned proposition is achieved by a photochromic-decorated body member being a body member to be exterior parts of a portable device used both outdoors and indoors and having a coating film containing a photochromic dye provided on at least a part of an internal surface of a transparent base material.

The aforementioned proposition can also be achieved by a photochromic-decorated body member corresponding to the above-described photochromic-decorated body member in which the transparent base material is made of a plastic.

The aforementioned proposition can also be achieved by a photochromic-decorated body member corresponding to the above-described photochromic-decorated body member in which the transparent base material made of the plastic has an ultraviolet absorbent diffused therein, the ultraviolet absorbent absorbs an ultraviolet ray having a wavelength shorter than a wavelength region in which a color developed by the photochromic dye is expressed.

The aforementioned proposition can also be achieved by a photochromic-decorated body member corresponding to the first described photochromic-decorated body member provided with a reflective layer being formed to cover the coating film containing the photochromic dye, and scattering and reflecting light transmitted through the transparent base material and the coating film containing the photochromic dye.

The aforementioned proposition can also be achieved by a photochromic-decorated body member corresponding to the above-described photochromic-decorated body member in which the reflective layer is an opaque paint film.

The aforementioned proposition can also be achieved by a photochromic-decorated body member corresponding to the above-described photochromic-decorated body member provided with a layer containing granular or flaky scatterers formed between the coating film containing the photochromic dye and the transparent base material.

The aforementioned proposition can also be achieved by a photochromic-decorated body member corresponding to the above-described photochromic-decorated body member in which the coating film is formed by a coating liquid generated by dissolving the photochromic dye in either of an acrylic resin, a polyurethane resin, and an epoxy resin, or in a resinous substance formed by mixing a combination of two or more of these resins.

The aforementioned proposition can also be achieved by a photochromic-decorated body member corresponding to the above-described photochromic-decorated body member in which the coating liquid contains a class of hindered amine light stabilizer or a class of hindered phenol light stabilizer.

### BRIEF DESCRIPTION OF THE DRAWINGS

FIG. 1 is a view illustrating an embodiment of a photochromic-decorated body member.

FIG. 2 is a view illustrating another embodiment of the photochromic-decorated body member.

FIGS. 3 (a) and (b) are views illustrating still another embodiment of the photochromic-decorated body member.

FIG. 4 is a view illustrating yet another embodiment of the photochromic-decorated body member.

FIG. 5 is a view for explaining characteristics of a photochromic dye and an ultraviolet absorbent.

FIG. 6 is a view illustrating still yet another embodiment of the photochromic-decorated body member.

### DETAILED DESCRIPTION OF THE EMBODIMENTS

### Embodiment 1

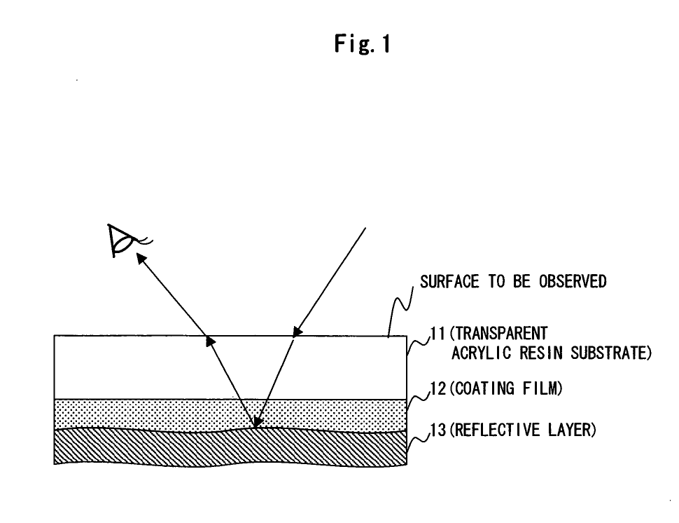

FIG. 1 illustrates an embodiment of a photochromic-decorated body member.

A body member illustrated in FIG. 1 is structured such that a coating liquid containing a photochromic dye is spray-painted on a transparent acrylic resin substrate 11 and then dried in an oven to form a coating film 12, and further, a white acrylic coating compound is spray-painted to cover the coating film 12 and then dried in the oven to form a reflective layer 13 made of a coating film.

The aforementioned coating liquid containing the photochromic dye is formed when, for instance, a dye solution formed by dissolving the photochromic dye in a solvent such as a thinner in which toluene is mixed is added to and diffused in an acrylic coating material. In forming processes of the coating film 12 containing the photochromic dye and the reflective layer 13 formed of the white coating compound, the coating films are dried by being put into the oven for 1 hour in which a temperature is adjusted to 60 degrees Celsius.

When the body member in which the coating film 12 containing the photochromic dye and the reflective layer 13 being the white-colored coating film are formed as described above is observed from a side of an unpainted surface of the transparent acrylic resin substrate 11, an appearance of white color is expressed in indoors by the reflective layer 13, and an appearance having a color provided by the photochromic dye diffused in the coating film 12 is expressed under solar rays.

A color developed by the photochromic dye expressed in outdoors by the body member of the embodiment illustrated in FIG. 1 is clearly observed with such a level that it can be favorably compared with a color developed by a photochromic dye expressed in outdoors by a photochromic-decorated body member disclosed in Application number 2006-198008 “METHOD FOR DECORATING BODY MEMBER WITH PHOTOCHROMIC DYE, PHOTOCHROMIC-DECORATED BODY MEMBER, AND BASE MATERIAL FOR BODY MEMBER” already applied by the present applicant.

Further, the solar rays are incident on the coating film 12 containing the photochromic dye via the transparent acrylic resin substrate 11, so that excessive ultraviolet rays that act on the photochromic dye molecules diffused in the coating film 12 containing the photochromic dye are reduced because of the ultraviolet absorption provided by the acrylic resin substrate 11.

Accordingly, it becomes possible to remarkably extend a duration of color developed by the coating film 12 containing the photochromic dye, and to achieve a significant improvement of a light fastness of the photochromic-decorated body member. The present applicant conducted a test in which the body member having a structure illustrated in FIG. 1 is exposed to an ultraviolet ray from a side on which the acrylic resin substrate 11 is exposed (represented by attaching arrow marks in FIG. 1) using an accelerated weathering machine with fluorescent ultraviolet lamp, and confirmed that dulling of the color developed by the photochromic dye was not occurred even after 150 hours of exposure.

Further, in the body member of the embodiment illustrated in FIG. 1, the painting of the coating liquid containing the photochromic dye or the white coating compound is applied to an opposite side of the observed surface of the transparent acrylic resin substrate 11, so that a smoothness of the observed surface of the transparent acrylic resin substrate 11 is reflected regardless of a smoothness of the coating film 12 containing the photochromic dye and the reflective layer 13 formed of the white coating compound formed in the aforementioned painting processes, which enables to give an impression to an observer that a top finish is performed in a quite smooth and even manner.

Note that a color of the reflective layer 13 formed over the coating film 12 containing the photochromic dye is not limited to the white color, and an opaque and highly bright light color such as a light blue color and a light pink color can be applied. Particularly, if a light color similar to the color developed by the photochromic dye is applied, it is possible to enhance the color developed by the photochromic dye in outdoors. Further, if a coating having a color other than the similar color is dared to be used for forming the reflective layer 13, it is also possible to express mixed colors of the color developed by the photochromic dye and the color of the reflective layer 13 in outdoors.

Further, because of an effect of scattering at an interface between the reflective layer 13 and the coating film 12 containing the photochromic dye, an amount of light emitted via the acrylic resin substrate 11 among light scattered by the photochromic dye molecules that absorb an energy of ultraviolet ray in the coating film 12 to develop the color increases as compared to a case in which the reflective layer 13 is not provided, so that the amount of light used for observation also increases. Therefore, a color of the coating liquid that forms the reflective layer 13 is preferably a color capable of obtaining a high reflectivity such as a highly bright color and a metallic color.

Further, when a pearly colored coating that satisfies the aforementioned conditions regarding the colors is used for forming the reflective layer 13, a more gorgeous appearance can be expressed in outdoors, since a color capable of being obtained by the development of the photochromic dye is added to pearlescence provided by the pearly colored reflective layer 13.

Further, it is also possible to use, instead of the transparent acrylic resin substrate 11, a resin substrate formed by using various transparent plastic materials such as polycarbonate, polystyrene, ABS resins, nylon, and polypropylene. In short, any material being transparent to visible light, having an ultraviolet absorption, and having a strength to protect an internal electronic component and the like from an external environment as a material of exterior parts, can be used as a base material to form the coating film 12 containing the photochromic dye and the reflective layer 13.

### Embodiment 2

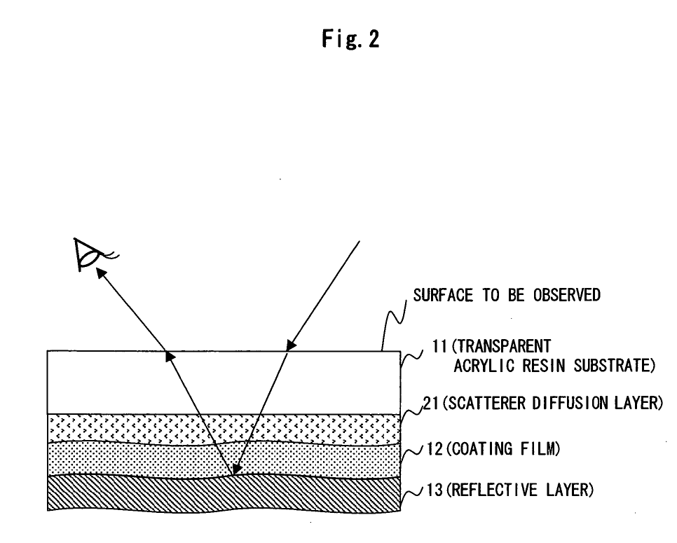

FIG. 2 illustrates another embodiment of the photochromic-decorated body member.

In the photochromic-decorated body member illustrated in FIG. 2, a scatterer diffusion layer 21 is formed between the transparent acrylic substrate 11 and the coating film 12 containing the photochromic dye illustrated in FIG. 1. The scatterer diffusion layer 21 is formed of an acrylic coating material in which glass beads stained to have the same color as the color developed by the photochromic dye are diffused.

Such a photochromic-decorated body member is obtained firstly by spray-painting the acrylic coating material in which the stained glass beads are diffused on the acrylic resin substrate 11, forming the scatterer diffusion layer 21 through the same drying process as that of the aforementioned embodiment 1, and then conducting the same process as that of the aforementioned embodiment 1, to thereby form the coating film 12 containing the photochromic dye and the reflective layer 13.

Note that the acrylic coating material used for forming the scatterer diffusion layer 21 can be formed by mixing, for instance, an acrylic coating material containing stained glass beads and a thinner containing toluene.

When the body member in which the scatterer diffusion layer 21, the coating film 12 containing the photochromic dye, and the white-colored reflective layer 13 are formed as described above is observed from a side of an unpainted surface of the transparent acrylic resin substrate 11, a sparkling appearance provided by the glass beads diffused in the scatterer diffusion layer 21 is expressed in indoors with the white color provided by the reflective layer 13 as a background. Further, under the solar rays, a gorgeous appearance is expressed in which the color developed by the photochromic dye and the sparkle provided by the glass beads are more enhanced by the color developed by the photochromic dye diffused in the coating film 12 and the color stained in the glass beads diffused in the scatterer diffusion layer 21.

The color developed by the photochromic dye expressed in outdoors by the body member of the embodiment illustrated in FIG. 2 is clearly observed with such a level that it can be favorably compared with the color developed by the photochromic dye expressed in outdoors by the photochromic-decorated body member disclosed in the aforementioned prior application.

Further, the solar rays are incident on the coating film 12 containing the photochromic dye via the transparent acrylic resin substrate 11, which is the same as the aforementioned embodiment 1, so that a duration of color developed by the coating film 12 containing the photochromic dye is remarkably extended, and a significant improvement of a light fastness of the photochromic-decorated body member can be obtained. The present applicant conducted a test in which the body member having a structure illustrated in FIG. 2 is exposed to an ultraviolet ray, in the same manner as in the light fastness test explained in the aforementioned embodiment 1, and confirmed that dulling of the color developed by the photochromic dye was not occurred even after 150 hours of exposure.

Further, also in the body member of the embodiment illustrated in FIG. 2, the painting of the coating liquid containing the photochromic dye or the white coating compound is similarly applied to an opposite side of the observed surface of the transparent acrylic resin substrate 11, so that similar to the photochromic-decorated body member according to the aforementioned embodiment 1, the body member can impress upon an observer a feel of materials with high level of smoothness and evenness in which one can hardly sees a fluctuation of the painted surface.

Note that it is also possible to form, instead of the scatter diffusion layer 21 containing the glass beads illustrated in FIG. 2, a coating film containing flaky scatterers such as pearls between the coating film 12 containing the photochromic dye and the transparent acrylic resin substrate 11.

For instance, when a paint film in which pearls are diffused is formed between the coating film 12 containing the photochromic dye and the transparent acrylic resin substrate 11, an appearance in which an effect inherent to the pearls is added to the color developed by the photochromic dye can be expressed in outdoors.

### Embodiment 3

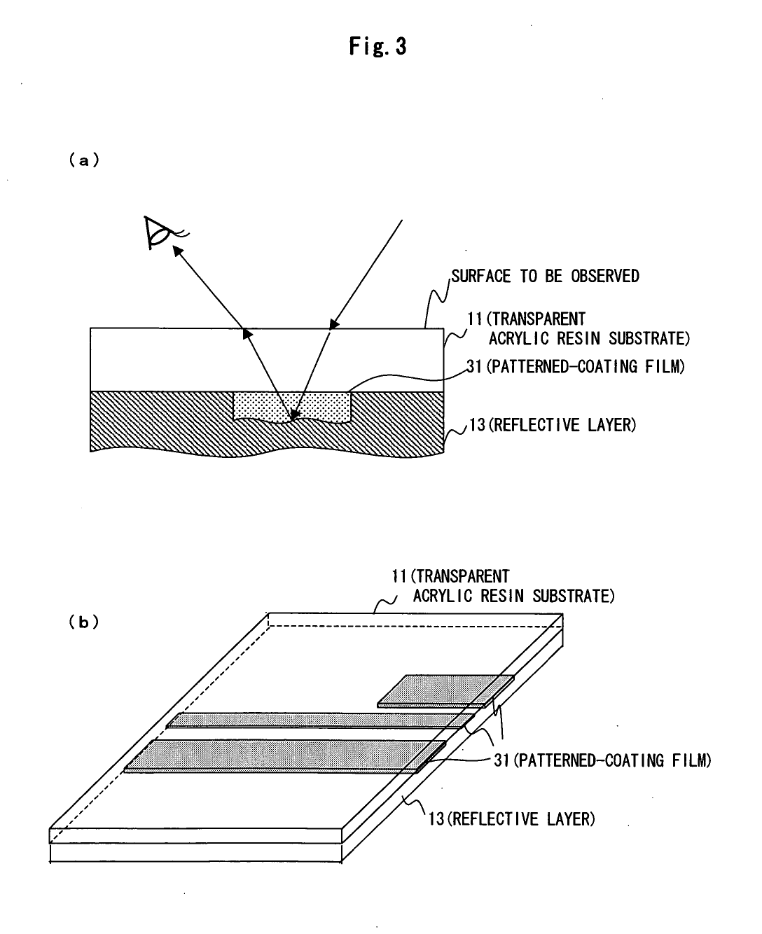

FIGS. 3(a) and 3(b) illustrate still another embodiment of the photochromic-decorated body member.

In the photochromic-decorated body member illustrated in FIG. 3(a), a patterned-coating film 31 containing the photochromic dye is formed so as to partially cover the transparent acrylic resin substrate 11. The patterned-coating film 31 can be formed by spray-painting a coating liquid containing the photochromic dye while masking a part of the transparent acrylic resin substrate 11, or by partially adhering the coating liquid containing the photochromic dye to the substrate by using a printing technique and the like.

For example, a photochromic dye-containing ink is formed by adding a photochromic dye solution to a resin for ink and kneading these mixture, the photochromic dye solution being formed by dissolving the photochromic dye in a solvent such as ethyl ketone. The photochromic dye-containing ink is used as an ink for screen printing to perform printing processing, which enables to make the photochromic dye-containing ink adhere to the transparent acrylic resin substrate 11 in a pattern shape of a desired figure, character and the like, as illustrated in FIG. 3(b).

The pattern of the photochromic dye-containing ink thus adhered in accordance with the desired shape is dried through the same drying process as that of the aforementioned embodiment 1, to thereby form the patterned-coating film 31 containing the photochromic dye having the desired shape. Further, through the same process as that of the embodiment 1, the reflective layer 13 having a white color or a light color is formed to cover the patterned-coating film 31 containing the photochromic dye formed in the desired shape and the transparent acrylic resin substrate 11 that is not covered by the patterned-coating film 31 (refer to FIG. 3(a)).

When the body member in which the patterned-coating film 31 containing the photochromic dye formed in the desired shape, and the white-colored reflective layer 13 are formed as described above is observed from a side of an unpainted surface of the transparent acrylic resin substrate 11, an appearance of white color or light color provided by the reflective layer 13 is expressed in indoors, and under the solar rays, an appearance in which the color developed by the photochromic dye is appeared in a shape of the patterned-coating film 31 formed by the screen printing is expressed with the white color or light color provided by the reflective layer 13 as a background.

The color developed by the photochromic dye expressed in outdoors by the body member of the embodiment illustrated in FIG. 3 is clearly observed with such a level that it can be favorably compared with the color developed by the photochromic dye expressed in outdoors by the photochromic-decorated body member disclosed in the aforementioned prior application.

Further, the solar rays are incident on the patterned-coating film 31 containing the photochromic dye via the transparent acrylic resin substrate 11, which is the same as the aforementioned embodiment 1, so that a duration of color developed by the patterned-coating film 31 containing the photochromic dye is remarkably extended, and a significant improvement of a light fastness of the photochromic-decorated body member can be obtained. The present applicant conducted a test in which the body member having a structure illustrated in FIG. 3 is exposed to an ultraviolet ray, in the same manner as in the light fastness test explained in the aforementioned embodiment 1, and confirmed that dulling of the color developed by the photochromic dye was not occurred even after 150 hours of exposure.

Further, also in the body member of the embodiment illustrated in FIG. 3, the painting of the coating liquid containing the photochromic dye or the white coating compound is similarly applied to an opposite side of the observed surface of the transparent acrylic resin substrate 11, so that similar to the photochromic-decorated body member according to the aforementioned embodiment 1, the body member can impress upon an observer a feel of materials with high level of smoothness and evenness in which one can hardly sees a fluctuation of the painted surface.

### Embodiment 4

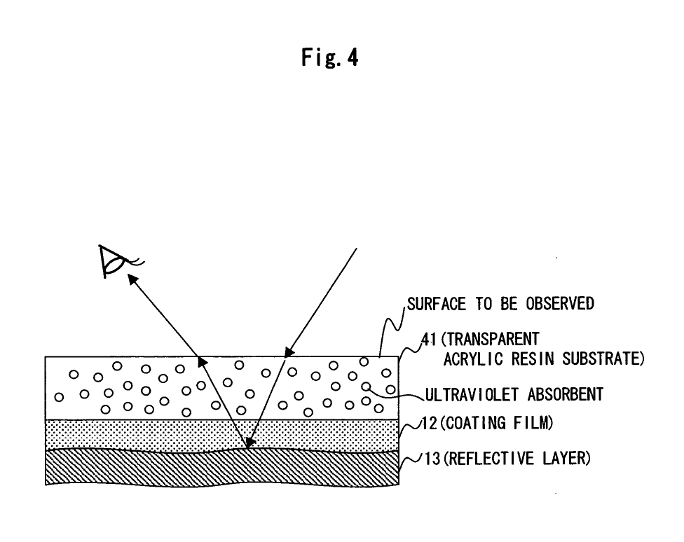

FIG. 4 illustrates yet another embodiment of the photochromic-decorated body member.

The photochromic-decorated body member illustrated in FIG. 4 is obtained by forming the coating film 12 containing the photochromic dye on an internal surface of, not the transparent acrylic resin substrate 11 illustrated in FIG. 1, but a transparent resin substrate 41 in which an ultraviolet absorbent is diffused, and then forming the white-colored or light-colored reflective layer 13 over the coating film 12.

The transparent resin substrate 41 in which the ultraviolet absorbent is diffused can be obtained by adding the ultraviolet absorbent having an appropriate absorption band to a transparent pelletized resin and melting these mixture, and the resultant is formed into a plate shape utilizing a molding technique such as injection molding, the transparent pelletized resin being such as, for instance, acrylic, polycarbonate, polystyrene, ABS resins, nylon, and polypropylene. Further, any material, other than the aforementioned plastic material, being transparent to visible light, having an ultraviolet absorption, and having a strength to protect an internal electronic component and the like from an external environment as a material of exterior parts, can be used as a base material to form the coating film 12 containing the photochromic dye and the reflective layer 13.

When the body member in which the coating film 12 containing the photochromic dye, and the white-colored or light-colored reflective layer 13 are formed on the inside of the transparent resin substrate 41 in which the ultraviolet absorbent is diffused as described above is observed from a side of an unpainted surface of the transparent resin substrate 41, an appearance of white color or light color provided by the reflective layer 13 is expressed in indoors, and under the solar rays, an appearance having a color developed by the photochromic dye diffused in the coating film 12 is expressed.

The color developed by the photochromic dye expressed in outdoors by the body member of the embodiment illustrated in FIG. 4 is clearly observed with such a level that it can be favorably compared with the color developed by the photochromic dye expressed in outdoors by the photochromic-decorated body member disclosed in the aforementioned prior application.

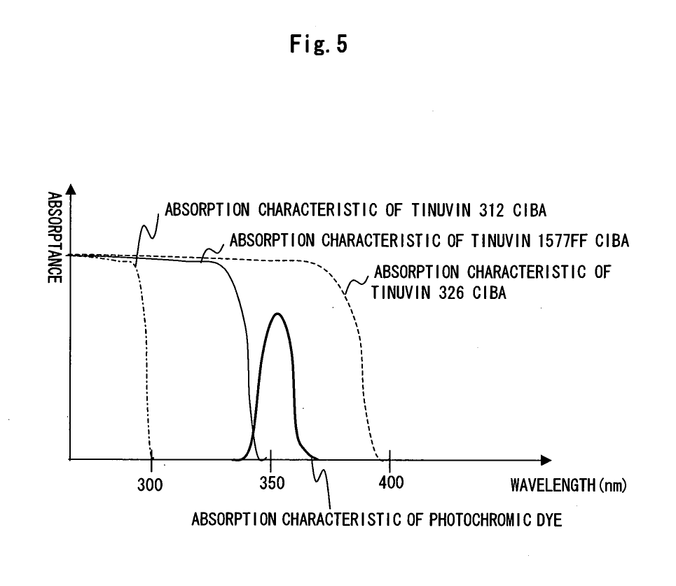

Here, as illustrated in FIG. 5, the photochromic dye has an absorption band in the vicinity of a wavelength of 350 nm, and a color developing process is achieved when an energy of ultraviolet ray in the wavelength region is absorbed. This is because a wavelength corresponding to an energy that breaks a bond between a spiro-carbon atom and an oxygen atom in a dye molecular structure of a spirooxazine type photochromic dye is about 340 nm, for instance, and the photochromic dye molecule becomes to have a structure to absorb a specific wavelength band due to the breakage of the bond.

Therefore, as represented by a thin solid line in FIG. 5, by forming the transparent resin substrate 41 using an ultraviolet absorbent having a characteristic of absorbing a relatively high energy ultraviolet ray whose wavelength is 340 nm or less, it is possible to prevent an excessive consumption of the photochromic dye while making the ultraviolet ray having a wavelength within the region to cause the color developing process reach the coating film 12 containing the photochromic dye.

As an ultraviolet absorbent having an absorption characteristic as described above, a TINUVIN 1577FF CIBA or the like has been known, and the present applicant performed the light fastness test explained in the aforementioned embodiment 1 on the photochromic-decorated body member formed by applying the above ultraviolet absorbent, and confirmed that the light fastness was remarkably improved.

Meanwhile, as represented by a thin dotted line in FIG. 5, if an ultraviolet absorbent (TINUVIN 326 CIBA, for instance) having a characteristic of absorbing an ultraviolet ray having a wide wavelength region of 400 nm or less is applied, a color development performance in outdoors was observed to be deteriorated since the ultraviolet ray having the wavelength region that reaches and cause the color developing process in the coating film 12 containing the photochromic dye is reduced. Further, as represented by a thin dashed line in FIG. 5, if an ultraviolet absorbent (TINUVIN 312 CIBA, for instance) having a characteristic of selectively absorbing a high energy ultraviolet ray whose wavelength is 300 nm or less is applied, although the color development of the photochromic dye is not hindered, an effect of preventing the excessive consumption of the photochromic dye is decreased, which was confirmed by a light fastness test similar to the aforementioned one.

Further, also in the body member of the embodiment illustrated in FIG. 4, the painting of the coating liquid containing the photochromic dye or the white coating compound is similarly applied to an opposite side of the observed surface of the transparent acrylic resin substrate 11, so that similar to the photochromic-decorated body member according to the aforementioned embodiment 1, the body member can impress upon an observer a feel of materials with high level of smoothness and evenness in which one can hardly sees a fluctuation of the painted surface.

### Embodiment 5

Hereinafter, a forming method of a coating liquid used for forming the coating film containing the photochromic dye in the aforementioned respective embodiments will be described in detail.

Generally, a coating is formed of a resin, a diluent that dissolves the resin and controls a performance (leveling characteristics, volatilization speed, and the like) of a coating film to be, and a coloring agent, in which an additive such as a delusterant is mixed according to need.

For example, when an acrylic resin being a typical resinous substance is used, a diluent appropriate for dissolving the acrylic resin and making the resin into a coating film is selected, and the photochromic dye to be a coloring agent is dissolved in the diluent, to thereby form a dye solution. When a relationship between a dissolving amount of the photochromic dye and a color strength expressed under the solar rays by a product having the formed coating film is previously examined within a range of a solubility in the diluent through an experiment and the like, it is possible to determine, based on the experimental result, the dissolving amount capable of obtaining a desired color strength. Note that in the coating liquid used for forming the coating film containing the photochromic dye in the aforementioned embodiments, the dye solution in which 2 mass percent of photochromic dye with respect to the diluent is dissolved is mixed.

The aforementioned acrylic resin and a hardening agent for hardening the resin are mixed in the photochromic dye solution generated as described above, and the mixture is sufficiently stirred to generate the coating liquid containing the photochromic dye. A ratio of mixture of the acrylic resin and the photochromic dye solution can be determined by considering a required film thickness, the leveling characteristics as the coating film obtained as a result of the mixture, and the like.

Note that also when a polyurethane resin, an epoxy resin, or a mixture of the acrylic resin, the polyurethane resin, and the epoxy resin is used as the resinous substance of the coating liquid, by selecting a diluent suitable for the resinous substance to dissolve the photochromic dye, and mixing the obtained photochromic dye solution and the resinous substance in the same manner, it is possible to generate a coating liquid suitable for forming a coating film containing the photochromic dye.

### Embodiment 6

Hereinafter, a forming method of a coating liquid with which the light fastness of the coating film containing the photochromic dye in the aforementioned respective embodiments is further improved will be described in detail.

As explained in the description of the embodiment 4, when the ultraviolet absorbent is diffused in the transparent resin substrate 41 illustrated in FIG. 4, light (including both visible light and ultraviolet ray) having an energy equal to less than the aforementioned energy with such a level that it breaks the bond between the spiro-carbon atom and the oxygen atom selectively reaches the coating film containing the photochromic dye.

In this case, the energy of the light that reaches the coating film does not break a bond other than the bond between the spiro-carbon atom and the oxygen atom in the photochromic dye molecule. However, a part of the photochromic dye molecule and the other coating substances may absorb the energy of the light to be an active radical, and such a radical may cause a chain reaction of breakage of various bonds including the bond other than the bond between the spiro-carbon atom and the oxygen atom in the photochromic dye molecule. Further, unlike the breakage of the bond between the spiro-carbon atom and the oxygen atom, the above-mentioned breakage of various bonds is an irreversible reaction, so that the radical as described above can be a factor of significantly deteriorating the light fastness of the coating film and the photochromic dye.

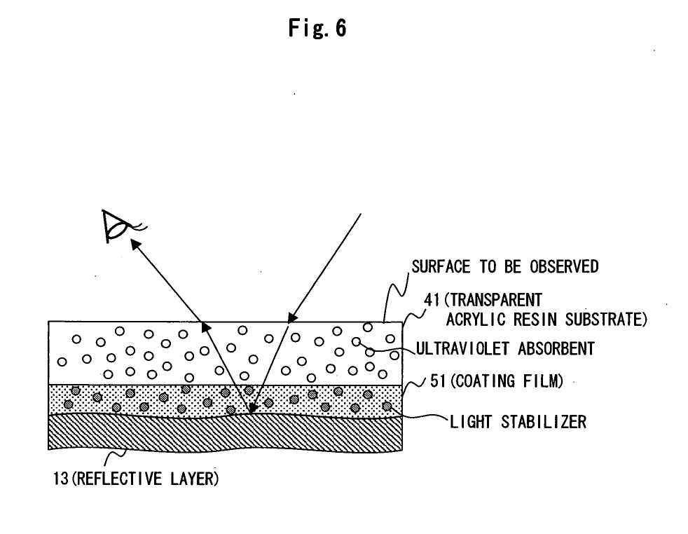

Such a deterioration due to the radical can be prevented by forming a coating film 51 containing not only the photochromic dye but also a light stabilizer as illustrated in FIG. 6, by mixing a class of hindered amine light stabilizer or a class of hindered phenol light stabilizer, as an additive, in the coating liquid containing the photochromic dye described in the aforementioned embodiment 5. Such a coating film 51 is formed by, for instance, generating a coating liquid containing the spirooxazine type photochromic dye in the same manner as described in the aforementioned embodiment 5, adding a class of hindered amine light stabilizer to the coating liquid obtained above, and by spray-painting a coating liquid obtained from these mixture on the internal surface of the transparent resin substrate 41 containing the ultraviolet absorbent.

In the coating film 51 formed as described above, the radical generated by absorbing the light that reaches the coating film 51 gets trapped by the aforementioned light stabilizer, so that the chain reaction of breakage of the various bonds in the molecular structure of the photochromic dye molecule, the resinous substance that forms the coating film, and the like, can be suppressed.

The present applicant conducted a light fastness accelerated test in which the coating film 51 of 10 μm formed by the aforementioned spray-painting is dried for 1 hour at 60 degrees Celsius, the reflective layer 13 is then formed by the white coating compound, and an ultraviolet ray is exposed from a side of an observed surface (unpainted surface) of the body member having a structure illustrated in FIG. 6 using a 340 nm ultraviolet light source of the QUV Weathering Tester, and confirmed, based on an observation performed under the solar rays after 150 hours of exposure, that no dulling of the color developed by the photochromic dye was occurred.

The photochromic-decorated body member disclosed in the above description can secure the light fastness with such a level that it can be used as exterior parts, by interposing the transparent base material between the external environment and the coating film containing the photochromic dye to reduce the deterioration of the photochromic dye.

Particularly, when a plastic is applied as the transparent base material, and further, an ultraviolet absorbent diffused in the plastic base material is made to absorb an ultraviolet ray having a short wavelength included in the solar rays, it is possible to further reduce the excessive consumption of the photochromic dye molecules and to improve the light fastness of the photochromic-decorated body member. Further, it is possible to achieve a greater light fastness by making a light stabilizer diffuse inside the coating film containing the photochromic dye, making the radical generated when the light that reaches inside the coating film acts on the coating or the photochromic dye get trapped by the light stabilizer, and by breaking a chain reaction in which the radical acts on the photochromic dye molecule or the coating film substance to be decomposed.

Further, by providing the reflective layer that covers the coating film containing the photochromic dye so that the light transmitted through the coating film containing the photochromic dye is scattered and reflected, and emitted via the transparent base material, the color developed by the photochromic dye can be expressed more clearly.

As described above, the photochromic-decorated body member disclosed in the above description has a decoration using the photochromic dye applied to the inside of the transparent material thereof, so that it is provided with a light fastness with such a level that it can sufficiently fulfill the usage as a material of exterior parts while exhibiting an effect of photochromic decoration.

Accordingly, it becomes possible to overcome the low light fastness, which has been a problem when applying the photochromic-decorated body member to exterior parts of an electronic device, so that the body member is quite useful in the field of exterior parts of a camera, a mobile phone, a notebook computer, an attached device such as a wireless LAN adapter and a card reader attached to the notebook computer, and a portable device typified by a portable music player.

The many features and advantages of the embodiments are apparent from the detailed specification and, thus, it is intended by the appended claims to cover all such features and advantages of the embodiments that fall within the true spirit and scope thereof. Further, since numerous modifications and changes will readily occur to those skilled in the art, it is of desired to limit the inventive embodiments to exact construction and operation illustrated and described, and accordingly all suitable modifications and equivalents may be resorted to, falling within the scope thereof.

1. A photochromic-decorated body member being a body member to be exterior parts of a portable device used both outdoors and indoors, comprising:
a coating film containing a photochromic dye provided on at least a part of an internal surface of a transparent base material.

2. The photochromic-decorated body member according to claim 1, wherein
the transparent base material is made of a plastic.

3. The photochromic-decorated body member according to claim 2, wherein
the transparent base material made of the plastic has an ultraviolet absorbent diffused therein, the ultraviolet absorbent absorbing an ultraviolet ray having a wavelength shorter than a wavelength region in which a color developed by the photochromic dye is expressed.

4. The photochromic-decorated body member according to claim 1, further comprising
a reflective layer being formed to cover the coating film containing the photochromic dye, and scattering and reflecting light transmitted through the transparent base material and the coating film containing the photochromic dye.

5. The photochromic-decorated body member according to claim 4, wherein
the reflective layer is an opaque paint film.

6. The photochromic-decorated body member according to claim 4, further comprising
a layer containing one of granular and flaky scatterers formed between the coating film containing the photochromic dye and the transparent base material.

7. The photochromic-decorated body member according to claim 3, wherein
the coating film is formed by a coating liquid generated either by dissolving the photochromic dye in one of an acrylic resin, a polyurethane resin, and an epoxy resin, or by dissolving the photochromic dye in a resinous substance formed by mixing a combination of two or more of the acrylic resin, the polyurethane resin, and the epoxy resin.

8. The photochromic-decorated body member according to claim 7, wherein
the coating liquid contains one of a class of hindered amine light stabilizer and a class of hindered phenol light stabilizer.
